(19) United States
(12) Patent Application Publication
(10) Pub. No.: US 2014/0218130 A1
(43) Pub. Date: Aug. 7, 2014

(54) PHASE-SHIFTER AND POWER SPLITTER

(71) Applicants: Patrick Lecam, Lannion (FR); Jean-Pierre Harel, Lannion (FR); Thomas Julien, Lannion (FR)

(72) Inventors: Patrick Lecam, Lannion (FR); Jean-Pierre Harel, Lannion (FR); Thomas Julien, Lannion (FR)

(73) Assignee: ALCATEL LUCENT, Paris (FR)

(21) Appl. No.: 14/128,066

(22) PCT Filed: Jun. 28, 2012
(86) PCT No.: PCT/EP2012/062531

§ 371 Date: Mar. 18, 2014

(30) Foreign Application Priority Data
Jun. 30, 2011 (FR) 1155904

(51) Int. Cl. H01P 5/12; H01P 1/18

(52) U.S. Cl. CPC H01P 5/08; H01P 1/18
USPC 333/136; 333/156

(57) ABSTRACT

An integrated device comprises at least one input connector (62) linked to an internal conductive line (64) and at least two output connectors (70A,70B) each respectively linked to an conductive branch (69A, 69B), wherein a single moving part (65), simultaneously serving the functions of a phase-shifter and a power-distributor, which comprises a shared segment (67) divided into two conductive arms (68A, 68B), the shared segment (67) linking the internal conductive line (64) to each of the conductive branches (69A, 69B) respectively, so as to vary, by an equal but opposite quantity, the length of the electric path between the input connector (62) and each of the output conductors (70A,70B) when the moving part (65) moves. The moving part (65) can be actuated from outside the housing, preferentially by means of a transmission bar (66).

### CROSS-REFERENCE

This application is based on French Patent Application N° 11 55 904 filed on Jun. 30, 2011, the disclosure of which is hereby incorporated by reference thereto in its entirety, and the priority of which is hereby claimed under 35 U.S.C. §119.

### TECHNICAL FIELD

The present invention relates to a device that provides the functions of a phase shifter and a power splitter (or power distributor) intended to be used in an antenna.

### BACKGROUND

Panel antennas used for modern radio communications most commonly integrate electromechanical devices known as phase shifters whose purpose is to alter the antenna's electrical tilt, meaning the direction of the main lobe of the antenna's radiation pattern. Many different types of phase shifters exist. These phase-shifting devices combined with power-splitting devices are incorporated into antennas, thereby forming complete feed networks.

“Trombone” phase-shifting devices are known and widely used, particularly in laboratories that work with radio frequencies, as they offer a large range of phase shifting combined with a very broad usable frequency band.

Devices for distributing electrical or radio frequencies power make it possible to separate an incident electrical signal into multiple fixed-phase components with different electrical power levels.

The feed networks of panel antennas must comprise devices that have the function of a phase shifter and the function of a power distributor in order to suitably feed each of the antenna's radiating elements, meaning to feed them with electromagnetic signals that have determined phases and amplitudes.

### SUMMARY

There is a perceived need to combine these two essential functions within a single device, for a substantially smaller cost and volume.

It is therefore a purpose of the invention to combine the two functions of phase-shifting and power-distributing in a single integrated shared two-function device.

It is a further purpose of the invention to propose an integrated device with a very large phase-shift range combined with a power distribution function.

The purpose of the present invention is a device that comprises at least one input connector connected to an internal conductive line and at least two output connectors, each one respectively connected to a conductive branch.

The device comprises a single moving part, which simultaneously provides the functions of a phase shifter and a power distributor, which comprises a shared segment divided into two conducting arms, the shared segment connecting the internal conductive line to each of the conductive branches respectively, so as to vary, by an equal but opposite quantity, the length of the electrical path between the input connector and each of the output connectors when the moving part moves.

This two-function device integrates and merges the two functions of phase shifter and power distributor, such that they cannot be dissociated without altering the device, particularly by adding additional elements. The phase shifting system is activated by moving a single part with a T-shaped profile, so there is no need to move two separate parts as in “trombone”-style devices of the prior art.

The distribution of power between the output connectors is fixed by the dimensions of the internal conductive line and the conductive branches to be traveled by the incoming electromagnetic signal. During the phase shift, the increase in the electrical path between the input connector and one of the output connectors leads to a decrease in the electrical path between the input connector and the other output connector in the same proportion.

In a first variant, the device's moving part may move along a translation motion.

In a second variant, the moving part may move along a rotation motion.

According to a first aspect, the ends of the moving part are respectively inserted into the internal conductive line and into the conductive branch. If so, the internal conductive line and the conductive branch are hollow and slightly greater in diameter than the mobile part, which allows them to slide like a trombone along the moving part in order to adjust the phase shift.

According to a second aspect, the internal conductive line and the conductive branch are each inserted respectively into the ends of the moving part. If so, the moving part is hollow and slightly greater in diameter than the internal conductive line and conductive branch, which allows them to slide like a trombone along the internal conductive line and the conductive branch in order to adjust the phase-shifting.

The device preferentially comprises a conductive housing. This housing is, for example, metallic.

In one preferred embodiment, the internal conductive line and the conductive branches have a stripline structure, the housing's walls placed on either side of the conductor, from which they are separated by an insulating element, serving as ground planes.

Advantageously, the moving part can be actuated from outside the housing.

In one embodiment, at least one moving part cooperates with a transmission bar. This transmission bar, accessible from outside the housing, makes it possible to set the moving part in motion.

It is an advantage of the present invention to meet the need for antennas that feature a satisfactory compromise in terms of RF performance, PIM behavior (for “Passive Inter-Modulation”), phase-shafting capability, and mechanical simplicity for a reduced cost.

Owing to the use of capacitive coupling to make the connection from the conductor to the housing, and to the sliding of the trombone's portions, the invention requires only a greatly reduced mechanical effort to be activated. Additionally, these capacitive couplings avoid disruptions due to intermodulation products (PIM).

The network topology, as a technical solution to be used, is naturally always chosen to correspond to the best possible compromise for the antenna's end use. The compromises relate to the RF performance of the network as a whole (such as VSWR “Voltage Standing Wave Ratio”), the stability of amplitude division over a broad frequency band, the phase-shifting capability, the PIM behavior, the simplicity and mechanical effectiveness (the number of parts needed and their complexity to activate phase-shifting, the accuracy obtained, the necessary torque, etc. . . . ) as well as the overall cost of the network's feed function as a whole.

### BRIEF DESCRIPTION

Other characteristics and advantages of the present invention will become apparent upon reading the following description of embodiments, which are naturally given by way of non-limiting examples, and in the attached drawing, in which:

FIG. 1 depicts a schematic diagram of a first embodiment of the device;

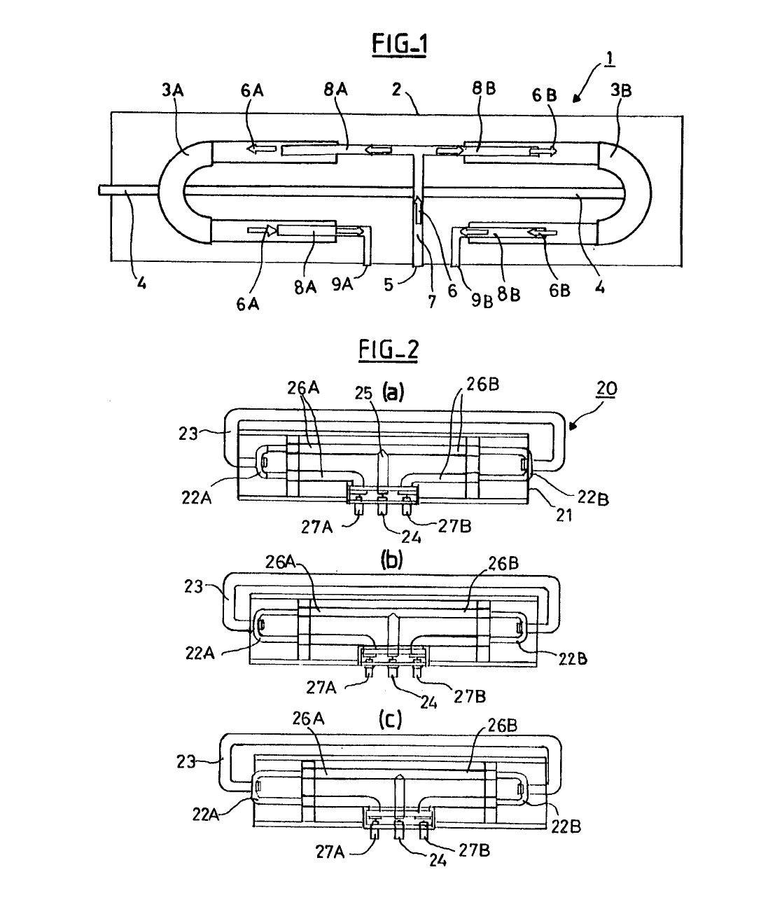

FIGS. 2a, 2b and 2c depict views in different positions of a first variant of the first embodiment of the device in the case of longitudinal movement;

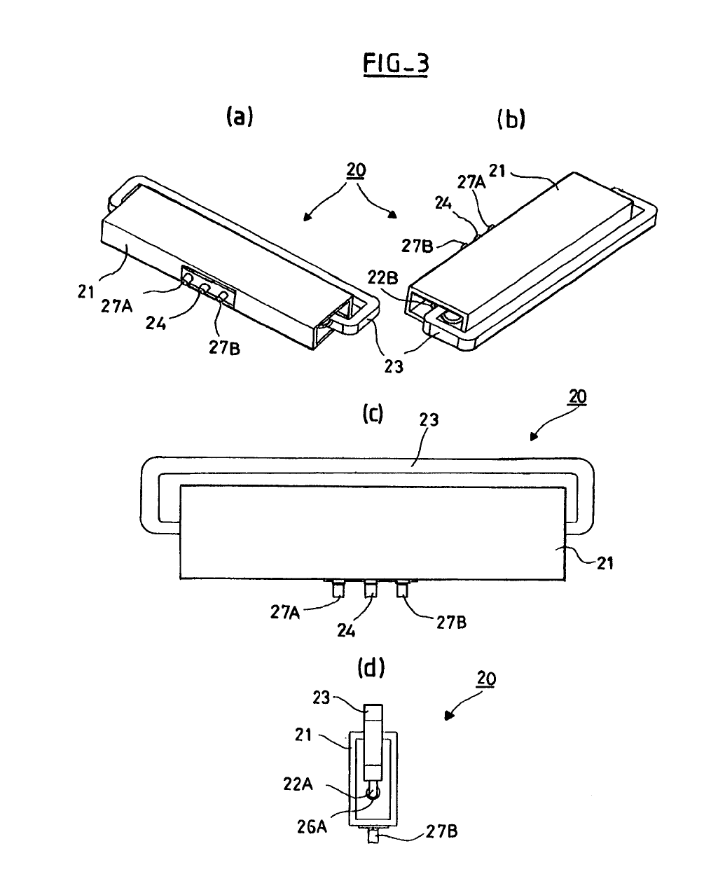

FIGS. 3a to 3d depict views from different angles (right and left perspective, top, side) of the device of FIGS. 2a-2c;

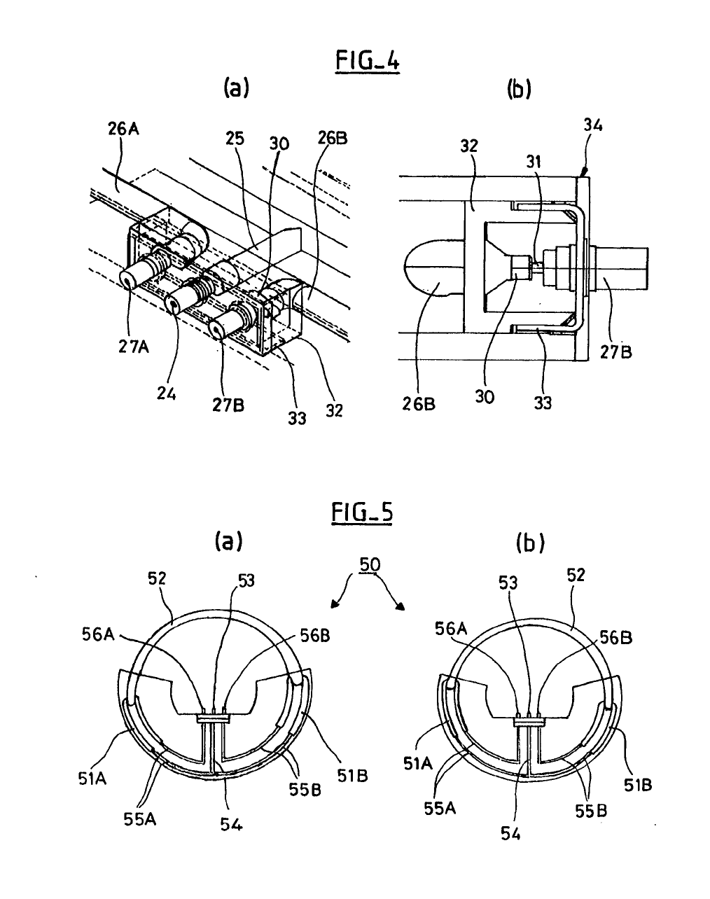

FIGS. 4a and 4b depict details of the input and output connections of the device of FIG. 2a-2c;

FIGS. 5a and 5b depict a schematic representative of a second variant of a first embodiment of the device in the event of rotational movement;

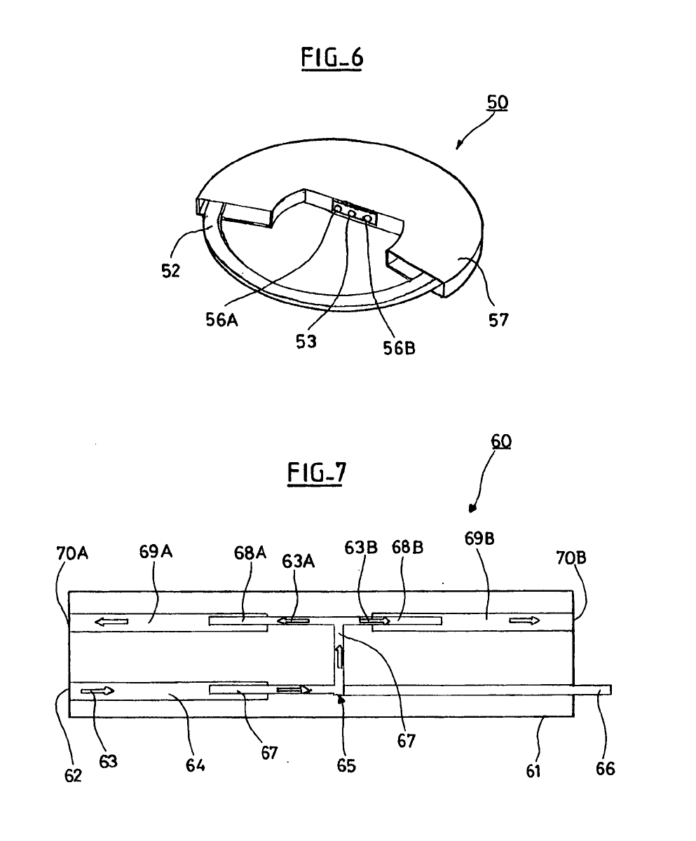

FIG. 6 depicts a perspective view of the device of FIGS. 5a and 5b;

FIG. 7 depicts a schematic representation of a second embodiment of the device in the case of longitudinal movement;

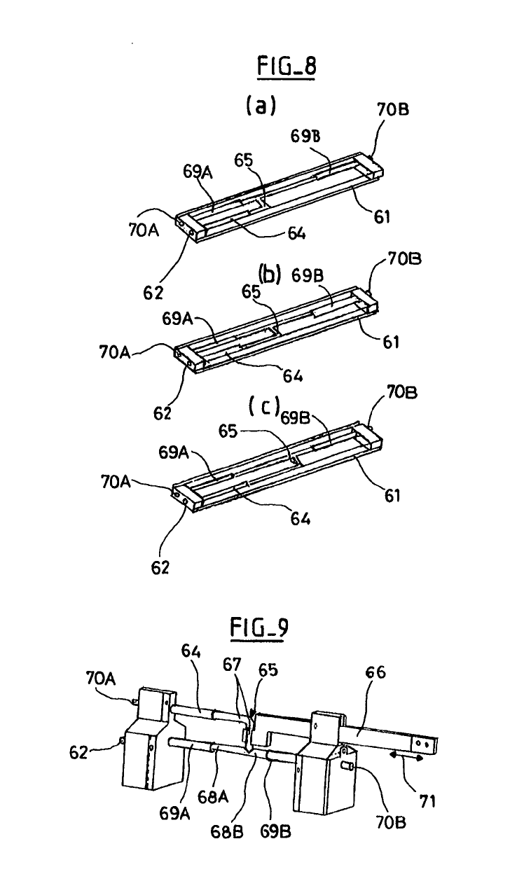

FIGS. 8a, 8b and 8c depict views in different positions of the second embodiment of the device;

FIG. 9 depicts a perspective view of the interior of the device of FIGS. 8a-8c;

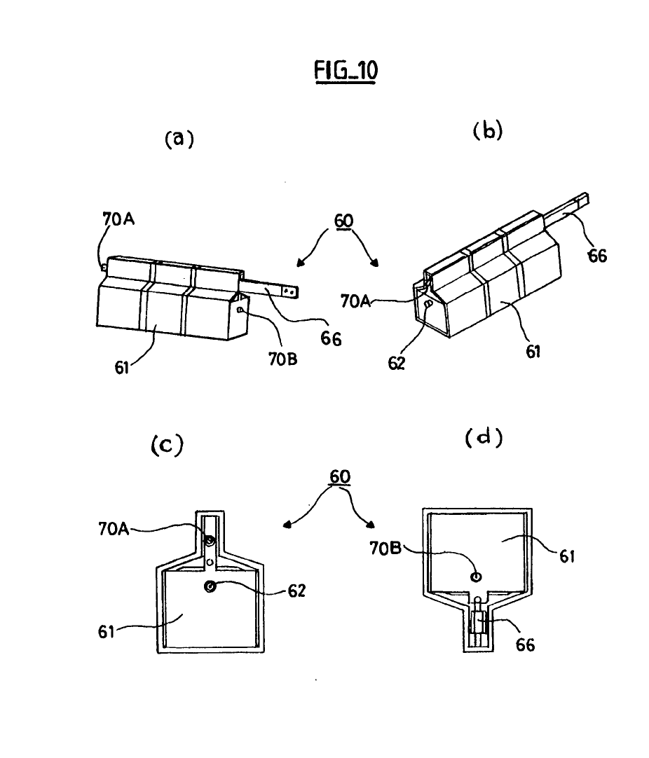

FIGS. 10a to 10d depict views from different angles (right and left perspective, top, right side, left side) of the device of FIGS. 8a-8c;

FIG. 11 depicts a perspective view of the connection block of one variant of the second embodiment of a device;

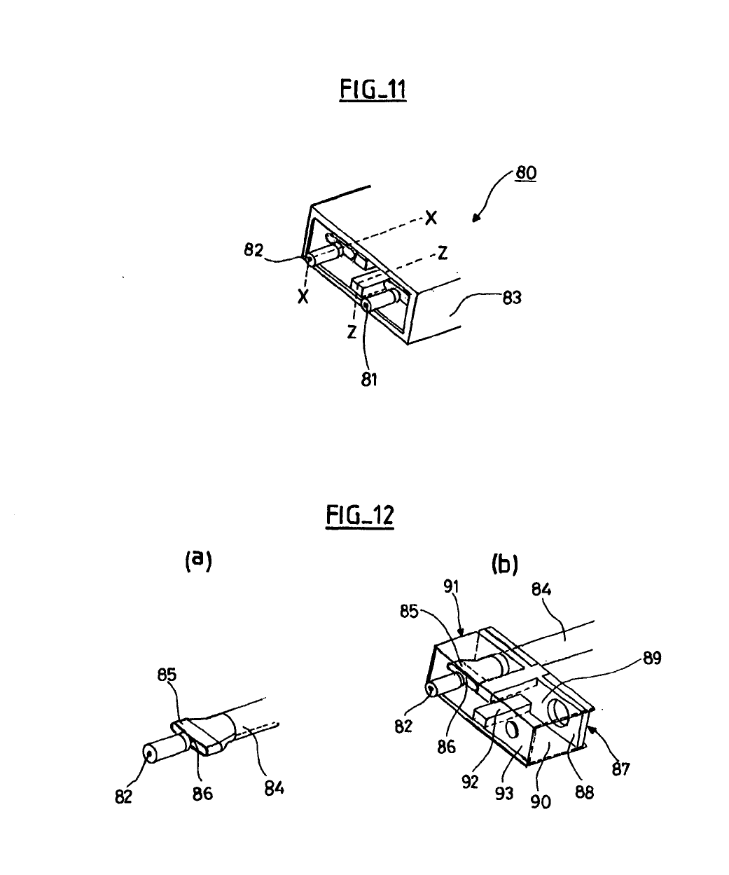

FIGS. 12a and 12b depict a perspective view of a connection of the connection block of FIG. 11;

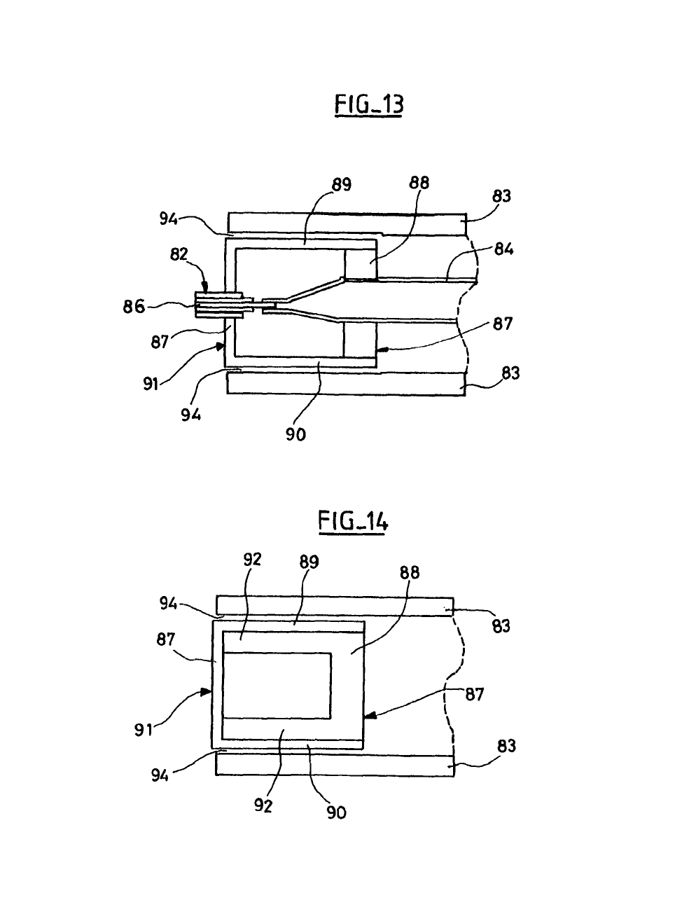

FIG. 13 depicts a cross-section schematic view along X-X of the connection block of FIG. 11;

FIG. 14 depicts a cross-section schematic view along Z-Z of the connection block of FIG. 11.

### DETAILED DESCRIPTION

FIG. 1 is a schematic depiction showing the operating principle of a first embodiment of an integrated device. The device 1 is a passive phase-shifter/power-splitter (or power distributor) component that comprises a housing 2, within which are housed two moving parts 3A and 3B made of a conducting material placed at each end of the housing 2. Each of the moving parts 3A and 3B is capable of being subjected to a translation motion owing to a transmission bar 4 made of dielectric material, in order to provide the phase-shifting function.

An input connector 5, such as for a coaxial cable connection, is located at the center of the device 1. The electromagnetic signal 6, which enters by the input connector 5, follows the internal conductive line 7 which may be formed of a metal rod; if so, the housing 2 is conductive and constitutes the external conductor of the conductive line 7 which may be likened to a coaxial cable. The internal conductive line 7 is divided into two conductive branches 8A and 8B, which are also made of metal, for example, in order to provide the power-splitter function. The two conductive branches 8A and 8B may also be likened to a coaxial cable whose conductive housing 2 constitutes the external conductor. The electromagnetic signal 6 is therefore divided into two electromagnetic signal portions 6A and 6B each following conductive branches 8A and 8B respectively. In this embodiment, it must be noted that the impedances of the input and output signals are not necessarily identical. In this example, the input impedance is optimized for 37.5 Ohms, while the output impedance is optimized for 75 Ohms. The end of each conductive branch 8A and 8B is respectively connected to one of the two moving parts 3A and 3B. The moving parts 3A and 3B are hollow, and of greater diameter than the conductive branches 8A and 8B, which enables them to slide like a trombone along the conductive branches 8A and 8B in order to adjust the phase shift. The sliding is achieved thanks to the transmission bar 4. The two electromagnetic signal portions 6A and 6B are then collected at the output connectors 9A and 9B respectively, which are here disposed on either side of the input connector 5.

The power distribution may be variable between the output connectors 9A and 9B, based on the dimensions of the internal conductive line 6 and of the conductive branches 8A and 8B. When the dielectric transmission bar 4 is moved, each of the electrical paths between the input connector 5 and the output connector 9A on one hand, and between the input connector 5 and the output connector 9B on the other, have a length that is consequently altered by an equal but opposite quantity. For example, when the electrical path between the input connector 5 and the output connector 9A increases, the electrical path between the input connector 5 and the output connector 9B is reduced in the same proportion, while the power distribution between the output connectors 9A and 9B remains unchanged.

According to a first aspect, consider the case in which the internal conductive line is a stripline comprising a conductor with a round cross-section, placed between two ground planes which are conductors, here the walls of the housing 2. For an internal conductive line which has an impedance Z₀ of 50 Ohms whose outer diameter d is 6 mm and which uses air as a dielectric layer, the distance h between the two conductive planes that frame it must be about 11 mm, applying the relationship (1):

Z₀=15In[1+1.314x+\sqrt{(1.314x)²}+2x]

x=(1+2h/d)⁴−1 (1)

According to a second aspect, consider the case in which the internal conductive line is a conductor with a round cross-section, placed between two ground planes which are conductive. For an internal conductive line that has an impedance Z₀ of 100 Ohms whose outer diameter d is 5 mm and which uses air as a dielectric layer, the distance h between the two conductive planes that frame it must be about 21 mm, applying the relationship (1):

According to a third aspect, consider the case where the internal conductive line is a conductor with a rectangular cross-section, also placed between two ground planes. For an internal conductive line that has an impedance Z₀ of 50 Ohms whose length W is 16 mm whose thickness t is 3 mm and that uses air as a dielectric layer, the distance h between the two conductive planes that frame it must be about 16.5 mm, applying the relationship (2):

$${Z}_{0} = 30 ln \{ 1 + \frac{8 h}{π {W}^{′}} [ \frac{16 h}{π {W}^{′}} + \sqrt{{( \frac{16 h}{π {W}^{′}} )}^{2} + 6.27} ] \} \\ {W}^{′} = W + \frac{t}{π} ln \{ {e [ {( \frac{1}{4 h \text{/} t + 1} )}^{2} + {( \frac{1 / 4 π}{W \text{/} t + 1.1} )}^{m} ]}^{- 1 / 2} \} \\ m = 2 / ( 1 + t / 3 h ) \qquad ( 2 )$$

The different configurations that such a device may take are illustrated in FIGS. 2a to 2c, which present a first variant of the embodiment of FIG. 1 in which the movement of the moving parts is longitudinal.

The device 20 comprises a conductive housing 21 within which are housed two conductive moving parts 22A and 22B that may be moved by means of a dielectric transmission bar 23. The transmission bar 23 is here placed partially outside the housing 21 so that it can be actuated manually. The electromagnetic signal enters the device 20 via an input 24 connector. Within the housing 21, the electromagnetic signal follows the internal conductive line 25 that split it into two conductive branches 26A and 26B respectively, disposed within and connected to the moving parts 22A and 22B. The electromagnetic signal leaves the device 20 via the output connectors 27A and 27B. The transmission bar 23 moves the moving parts 22A and 22B which slide like trombones along the conductive branches 26A and 26B of the internal conductive line 24. This motion makes it possible to apply a phase shift between the split RF signals traveling through the conductive branches 26A and 26B.

FIG. 2a depicts the case in which the moving part 22A is in its minimum position of displacement, while the moving part 22B is in its maximum position of displacement. The electromagnetic signal traveling within the conductive branch 26A between the input connector 24 and the output connector 27A has an electrical path to be traveled that is less than the one traveled by the electromagnetic signal running through the conductive branch 26B between the input connector 24 and the output connector 27B.

FIG. 2b depicts the case in which the moving parts 22A and 22B are in an intermediate position of displacement. Here, the electromagnetic signal traveling within the conductive branch 26A between the input connector 24 and the output connector 27A has an electrical path to be traveled that is close to the one traveled by the electromagnetic signal running through the conductive branch 26B between the input connector 24 and the output connector 27B.

FIG. 2c depicts the case in which the moving part 22A is in its maximum position of displacement, while the moving part 22B is in its minimum position of displacement. The electromagnetic signal traveling within the conductive branch 26A between the input connector 24 and the output connector 27A has an electrical path to be traveled that is greater than the one traveled by the electromagnetic signal running through the conductive branch 26B between the input connector 24 and the output connector 27B.

FIGS. 3a to 3d depict the device 20 seen from outside from different angles. FIGS. 3a and 3b in right and left perspective show, outside the housing 21, the input connector 24 and the output connectors 27A and 27B, as well the transmission bar 23, each end of which is respectively connected to one of the moving parts 22A and 22B placed inside the housing 21.

FIG. 3c from above also shows the input connector 24 and the output connectors 27A and 27B, as well as the transmission bar 23.

FIG. 3d from the side shows that the housing 21 is open on its two smaller sides so as to allow the transmission bar 23 to move freely, as well as to connect with the moving parts 22A and 22B placed inside the housing 21. Note that the moving part 22A, which is smaller in diameter, fits into the conductive branch 26A into which it slides.

FIGS. 4a and 4b depict details of embodiments of the input and output connectors of the device 20.

FIG. 4a shows through transparency the input connector 24 linked to the internal conductive line 25 and the output connectors 27A and 27B respectively linked to the conductive branches 26A and 26B. Each connector is coaxial. The link between the output connector 27B and the conductive branch 26B is produced by clamping 30 the end of the conductive branch 26B onto the internal conductor 31 of the output connector 27B. The same is true of the connector 26A. The input connector 24 could also be linked to the internal conductive line 25 in the same way.

FIG. 4b shows in detail the embodiment of the device 20 corresponding to the output connector 27B linked to the conducting branch 26B. The output connector 27B is kept in place by a reinforcement 32 made of dielectric material, which supports a protective lid 33 that it rests against. The assembly is covered by a conductive outer housing 34.

This configuration enables capacitive coupling between the outside conductor of the coaxial conducting branch 27b coaxial and the outer housing 34. Connection by capacitive coupling makes it possible to avoid contact by screws or welding, which is potentially a source of intermodulation-related problems. It also makes it possible to use, for the outer housing 34 non-weldable, less expensive, and lighter materials (such as, for example, aluminum in place of brass).

FIGS. 5a and 5b are transparency views that depict two configurations of another variant of the embodiment of FIG. 1 in which the moving parts and the conductive branches are curved, making their movement rotational. In the configurations depicted here, the rotation corresponds to an angle of ±10°.

The device 50 comprises two moving parts 51A and 51B linked by a concave transmission bar 52. The device 50 comprises a input connector 53 whereby the incoming electromagnetic signal is injected into the device 50. The input connector 53 is connected to an internal conductive line 54 which is divided into two conductive branches 55A and 55B respectively linked to the output connectors 56A and 56B. Here, the internal conductive line 54 has, for example, a structure comprising a conductive pattern carried by a mount. The conductive pattern is disposed in parallel with and a determined distance away from a fixed plate that functions as a ground plane, from which it is separated by a moving dielectric plate.

In FIG. 5a, the conductive branch 55A is in the position where the electrical path travelled by the electromagnetic signal is shortest, with the moving part 51A covering a large portion of the conductive branch 55A around which it slides. The conductive branch 55B is then in the position where the electrical path traveled by the electromagnetic signal is longest, with the moving part 51B covering a reduced portion of the conductive branch 55B.

In FIG. 5b, the conductive branch 55A is in the position where the electrical path travelled by the electromagnetic signal is longest, with the moving part 51A covering a reduced portion of the conductive branch 55A around which it slides. The conductive branch 55B is then in the position where the electrical path traveled by the electromagnetic signal is shortest, with the moving part 51B covering a large portion of the conductive branch 55B.

An external perspective view of the device 50 is depicted by FIG. 6. The device 50 comprising a housing 57 in which are placed the components just described. The transmission bar 52 extends out from the housing so that it can be handled from outside. The input connector 53 and the output connectors 56A and 56B protrude out from the housing 57 so that they can easily be linked to a coaxial cable, which may also be equipped with a connector, for example. This second variant has the advantage of being more compact that the first variant of the first embodiment. This is because, in the case of longitudinal movement, it is necessary to provide sufficient clearance to allow the transmission bar to move. In the event that the transmission bar moves rotationally, this clearance is no longer necessary.

The second embodiment depicted in FIG. 7 schematically represents the operating principle of a device 60 which is a passive phase-shifter/power-splitter (or power distributor) component. The device 60 comprises a housing 61 made of a conductive material. An input connector 62 of the electromagnetic signal is on one side of the device 60. The incoming electromagnetic signal 63 follows an internal conductive line 64, which is, for example, a hollow metal tube. A moving part 65 made of conductive material is placed in the center of the housing 61. The moving part 65 is capable of translation motion owing to a transmission bar 66 made of dielectric material which can be actuated from outside the housing 61. The moving part 65 is made up of a shared segment 67, such as a metal rod, for example, which fits into the conductive line 64. The shared segment 67 is divided into two conductive arms 68A and 68B, to serve the power-splitter function. Each of the conductive arms 68A and 68B is respectively linked to a conductive branch 69A and 69B. The incoming electromagnetic signal 63 first follows the internal conductive line 64 and the shared segment 67. Next, the electromagnetic signal 63 is divided into two electromagnetic signal portions 63A and 63B which each follow one of the conductive arms 68A and 68B then one of the conductive branches 69A and 69B respectively. The conductive branches 69A and 69B are respectively linked to output connectors 70A and 70B each placed on an opposite side of the housing 61. The power distribution may be variable between the outputs 70A and 70B, depending on the dimensions of the shared segment 67 and conductive arms 68A and 68B. When the dielectric transmission bar 66 is moved, each of the electrical paths between the input connector 62 and the output connector 70A on one hand, and between the input connector 66 and the output connector 70B on the other, have a length that is consequently altered by an equal but opposite quantity. When the moving part 65 undergoes translation movement, the path of the electromagnetic signal is respectively lengthened and shortened in the direction of each of the outputs 70A and 70B with respect to a median position. The phase of the signal at the output 70A, which is directly linked to the length of the path, is thereby modified, while the phase of the signal at the output 70B is also modified, but in reverse. The advantage of this device 60 is that it independently combines control of the signal's amplitude (splitting power between the outputs 70A and 70B) by altering the shape of the moving part 65 (for example, by varying the respective diameters of the conductive arms 68A, 68B) and controls the difference in the signal's phase between the outputs 70A and 70B by altering the position of the moving part 65.

The different configurations that such a device may take are depicted in FIGS. 8a to 8c.

In FIG. 8a, the moving part 65 is in its minimum position of displacement towards the side of the device 60 that bears the input connector 62. The electromagnetic signal travelling within the internal conductive line 64 then in the conductive branch 69A, between input connector 62 and the output connector 70A, has an electrical path to be traveled that is less than the path traveled by the electromagnetic signal traveling in the internal conductive line 64 then in the conductive branch 69B between the input connector 62 and the output connector 70B.

FIG. 8b depicts the case where the moving part 65 is in an intermediate position of displacement. Here, the electromagnetic signal traveling within the conductive branch 69B between the input connector 62 and the output connector 70B has an electrical path to be traveled that is close to the one traveled by the electromagnetic signal running through the conductive branch 69A between the input connector 62 and the output connector 70A.

In FIG. 8c, the moving part 65 is in its maximum position of displacement towards the side of the device 60 that bears the input connector 62. The electromagnetic signal travelling within the internal conductive line 64 then in the conductive branch 69A, between input connector 62 and the output connector 70A, has an electrical path to be traveled that is greater than the path traveled by the electromagnetic signal traveling in the internal conductive line 64 then in the conductive branch 69B between the input connector 62 and the output connector 70B.

When the moving part 65 moves 10 mm, the difference in phase between the input connector 62 and the output connectors 70A, 70B is about 16° to 700 MHz.

A perspective view of the device 60 with the housing 61 removed is depicted in FIG. 8. The moving part 65 is joined with the transmission bar 66 that protrudes out from the housing 61. The central segment 67 and the conductive arms 68A and 68B move as one in a longitudinal direction 71 by motion propelled by the transmission bar 66. The internal conductive line 64 and the conductive branches 69A and 69B are fixed. The central segment 67 and the conductive arms 68A and 68B, which have a smaller diameter, slide inside the internal conductive line 64 and the conductive branches 69A and 69B.

FIGS. 10a to 10d depict the device 60 seen from outside from different angles.

FIGS. 10a and 10b in right and left perspective show, outside the housing 61, the input connector 62 and the output connector 70A disposed one atop and the other on the side of the housing 61 on one hand, and the output connector 70B and transmission bar 66 on the other hand, visible on the opposite side of the housing 61.

FIGS. 10c and 10d depict the configuration of each of the sides in the frontal view. It shows the same components as those described above.

FIG. 11 shows in detail the connection block 80 of one variant of a second embodiment of a device. The connection block 80 comprises an input connector 81 and an output connector 82. The connection block is protected by a conductive outer housing 83, for example a metallic one.

FIGS. 12a and 12b show in detail the connection between an output connector 82 and a conductive branch 84.

FIG. 12a depicts a coaxial output connector 82. The link between the output connector 82 and the conductive branch 84 is produced by clamping 85 the end of the conductive branch 84 onto the internal conductor 86 of the output connector 82.

FIG. 12b shows by transparency the output connector 82 linked to the conductive branch 84. The output connector 82 is held in place by an armature 87 made of dielectric material. The armature 87 comprises a dielectric plate 88, which rests against two opposite faces 89 and 90 of a protective lid 91, itself a conductor, and protrusions 92 that are also made of dielectric material, which advance perpendicular to the dielectric plate 88 of the armature 87 in order to rest against another face 93 of the protective lid 91, which is perpendicular to the first two faces 89 and 90.

FIG. 13 is a schematic cross-section view along direction X-X indicated in FIG. 11, within the output connector 82, that depicts the capacitive coupling in the device's connection block. The output connector 82, comprising an internal conductor 86, is linked to the conductive branch 84. The conductive branch 84 is shaped like a hollow tube, and moves into position around the internal conductor 86 of the output connector 82. The overlap of the hollow end of the conductive branch 84 clamps the internal conductor 86, and thereby the electrical contact between the two conductors 84 and 86. The conductive branch 84 is supported by the dielectric plate 88 of the armature 87 that comes in contact with the surfaces 89 and 90 opposite the “U”-shaped protective cover 91. A thin plastic film, an insulating coat of paint or any other insulating component 94, is placed between the conductive outer housing 83 and the conducting protective lid 91, making it possible to insulate them from each other. Electromagnetic coupling is thereby obtained between the faces across the outer housing 83 and the protective lid 91. A capacitive link has been used here in order to avoid intermodulation products that may occur when conductive elements are not suitably linked together.

FIG. 14 is a schematic cross-sectional view along the direction Z-Z indicated in FIG. 11, at the protrusions 92. The dielectric plate 88 of the armature 87 comes in contact with the opposite surfaces 89 and 90 of the “U”-shaped protective lid 91, and the protrusions 92, which are perpendicular, rest against the transverse surface 87. A thin insulating film 94 is placed between the conductive outer housing 83 and the “U”-shaped conductive protective lid 91 in order to insulate them from one another.

Naturally, the present invention is not limited to the described embodiments, but is, rather, subject to many variants accessible to the person skilled in the art without departing from the spirit of the invention. In particular, it is conceivable to use a conductor with a round cross-section, but also an ovoid, square, rectangular, etc. one. A device has been described, with the function of a phase-shifter and power-distributor, comprising two outputs, but it is possible without departing from the scope of the invention to increase the number of outputs. Finally, it is possible to combine multiple devices in series or in parallel.

1. A device comprising at least one input connector linked to an internal conductive line and at least two output connectors each respectively linked to a conductive branch, whereby a single moving part, simultaneously serving the functions of a phase-shifter and a power distributor, which comprises a shared segment divided into two conductive arms, the shared segment linking the internal conductive line to each of the conductive branches respectively, so as to vary, by an equal but opposite quantity, the length of the electrical path between the input connector and each of the output connectors when the moving part moves.

2. A device according to claim 1, wherein the moving part moves along a translation motion.

3. A device according to claim 1, wherein the moving part moves along a rotation motion.

4. A device according to claim 1, wherein the ends of the moving part are respectively inserted into the internal conductive line and into the conductive branch.

5. A device according to claim 1, wherein the internal conductive line and the conductive branch are respectively inserted into each of the ends of the moving part.

6. A device according to claim 1, comprising a conductive housing.

7. A device according to claim 6, wherein the conductive line and the conductive branches have a stripline structure, the housing's walls placed on either side of the conductor, which they are separated from by an insulating element, serving as ground planes.

8. A device according to claim 6, wherein the moving part can be actuated from the outside of the housing.

9. A device according to claim 1, wherein at least one moving part cooperates with a transmission bar.
